(19) United States
(12) Patent Application Publication
(10) Pub. No.: US 2019/0156498 A1
(43) Pub. Date: May 23, 2019

(54) INFORMATION PROCESSING DEVICE, MEETING ASSIST SYSTEM, MEETING ASSIST METHOD, AND IMAGE FORMING APPARATUS

(71) Applicant: KYOCERA Document Solutions Inc., Osaka (JP)

(72) Inventor: Ryota TAMURA, Osaka-shi (JP)

(73) Assignee: KYOCERA Document Solutions Inc., Osaka (JP)

(21) Appl. No.: 16/192,525

(22) Filed: Nov. 15, 2018

(30) Foreign Application Priority Data
Nov. 20, 2017 (JP) 2017-222799
Nov. 20, 2017 (JP) 2017-222800

(51) Int. Cl. G06T 7/33; G06Q 10/10; G10L 15/10; G06Q 30/02

(52) U.S. Cl. CPC G06T 7/344; G06Q 30/02; G10L 15/10; G06Q 10/109

(57) ABSTRACT

An information processing device determines a meeting image representing contents of a meeting. The information processing device includes an image determination section. The image determination section determines at least one image among a plurality of candidate images as the meeting image on the basis of a result of voting on the candidate images. The candidate images represent contents of the meeting. Alternatively, the image determination section determines at least one image among a plurality of application images as the meeting image. The application images have been submitted to the information processing device.

### INCORPORATION BY REFERENCE

The present application claims priority under 35 U.S.C. § 119 to Japanese Patent Application No. 2017-222800, filed on Nov. 20, 2017 and Japanese Patent Application No. 2017-222799, filed on Nov. 20, 2017. The contents of these applications are incorporated herein by reference in their entirety.

### BACKGROUND

The present disclosure relates to an information processing device, a meeting assist system, a meeting assist method, and an image forming apparatus.

A known image display device displays an image on a display section. The image display device receives input of conversation voice of a user (meeting participant). The image display device recognizes the input conversation voice and converts the conversation voice to character data. The image display device extracts a keyword satisfying a specific condition from the character data. The image display device searches for an image corresponding to the extracted keyword from a plurality of predetermined images. The image display device displays the image (meeting image) found by the search on the display section.

### SUMMARY

An information processing device according to an aspect of the present disclosure determines a meeting image representing contents of a meeting. The information processing device includes an image determination section. The image determination section determines at least one image among a plurality of candidate images as the meeting image on the basis of a result of voting on the candidate images. The candidate images represent contents of the meeting. Alternatively, the image determination section determines at least one image among a plurality of application images as the meeting image. The application images have been submitted to the information processing device.

A meeting assist system according to another aspect of the present disclosure includes the information processing device and vote devices. Votes are cast for any of the candidate images through the vote device.

A meeting assist system according to another aspect of the present disclosure includes the information processing device, an image creation device, and a communication section. An application image among the application images is created through an operation performed on the image creation device. The communication section transmits information indicating the application image created through the operation performed on the image creation device to a receiving section included in the information processing device.

A meeting assist method according to another aspect of the present disclosure determines a meeting image by a meeting assist system implemented by a computer. The meeting image is an image to be displayed during a meeting. The meeting assist method includes determining by an image determination section included in the computer, at least one image among a plurality of candidate images as the meeting image on the basis of a result of voting on the candidate images. The candidate images represent contents of the meeting. Alternatively, the meeting assist method includes determining by the image determination section, at least one image among a plurality of application images as the meeting image. The application images have been submitted to the computer.

An image forming apparatus according to another aspect of the present disclosure includes the information processing device and an image forming device. The image forming device forms the meeting image on a sheet.

### BRIEF DESCRIPTION OF THE DRAWINGS

FIG. 1 is a block diagram illustrating a meeting assist system according to the first embodiment of the present disclosure.

FIG. 2A is a first diagram illustrating a vote reception screen.

FIG. 2B is a first diagram illustrating a vote input screen.

FIG. 3 is a first flowchart illustrating a process for determining a meeting image by the meeting assist system according to the first embodiment of the present disclosure.

FIG. 4 is a block diagram illustrating a meeting assist system according to the second embodiment of the present disclosure.

FIG. 5A is a second diagram illustrating a vote reception screen.

FIG. 5B is a second diagram illustrating a vote input screen.

FIG. 6 is a second flowchart illustrating a process for determining a meeting image by the meeting assist system according to the second embodiment of the present disclosure.

FIG. 7 is a third flowchart illustrating the process for determining the meeting image by the meeting assist system according to the second embodiment of the present disclosure.

FIG. 8 is a schematic cross-sectional view of an image forming apparatus.

### DETAILED DESCRIPTION

The following describes embodiments of the present disclosure with reference to the accompanying drawings. Note that elements that are the same or equivalent are labelled using the same reference signs in the drawings, and description of those elements will not be repeated.

### First Embodiment

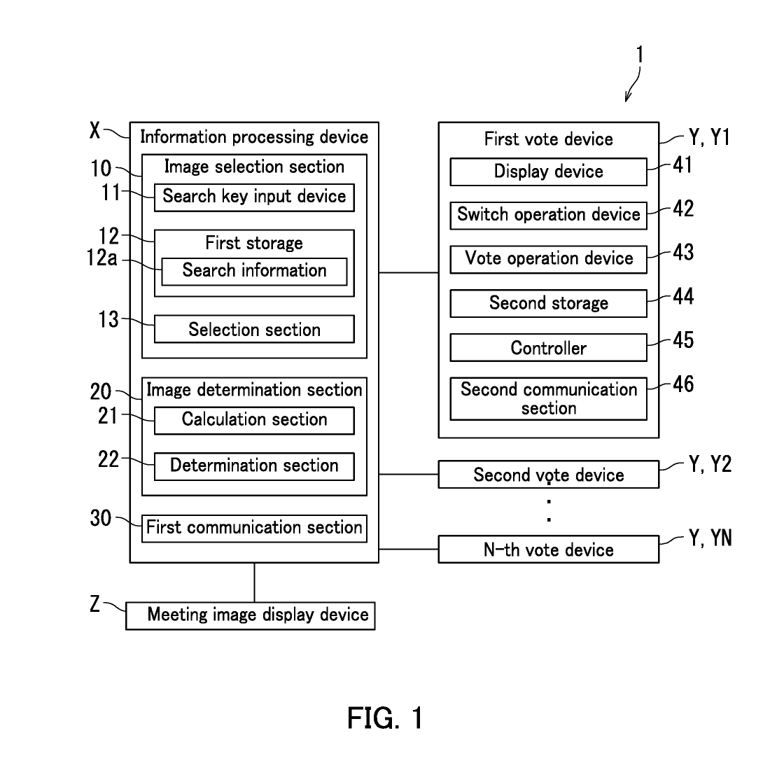

The following describes a meeting assist system 1 according to the first embodiment of the present disclosure with reference to FIG. 1. FIG. 1 is a block diagram illustrating the meeting assist system 1 according to the first embodiment of the present disclosure.

The meeting assist system 1 illustrated in FIG. 1 is for example used for a meeting adopting graphic recording. The graphic recording is a method of conducting a meeting in which contents of the meeting such as a statement of a meeting participant during the meeting or a discussion are represented by an image including an illustration and/or a diagram, for example, and the image representing the contents of the meeting is displayed to meeting participants during the meeting. The image representing the contents of the meeting will be referred to below as a meeting image. The meeting image is recorded for example as a minute of the meeting. Also, the meeting is conducted in such a state that the meeting participants can see the meeting image. Therefore, the meeting participants can review the contents of the meeting by seeing the meeting image. Also, as a result of the contents of the meeting being visualized with the meeting image, matter that is difficult to express with characters such as an atmosphere of the meeting can be expressed by the meeting image. Therefore, the meeting participants can deepen their understanding of the contents of the meeting. As a result, a hidden problem can for example be brought to light and quality of the discussion can be improved.

The meeting assist system 1 determines the meeting image. In the first embodiment, the meeting assist system 1 determines the meeting image through voting by the meeting participants.

The meeting assist system 1 includes an information processing device X.

The information processing device X includes an image selection section 10 and a first communication section 30.

The image selection section 10 selects a plurality of candidate images M. Each of the candidate images M is an image representing contents of the meeting. Each of the candidate images M is a candidate for the meeting image. The meeting participants cast votes for the candidate images M to determine the meeting image from among the candidate images M. Specifically, the image selection section 10 includes a search key input device 11, first storage (storage) 12, and a selection section 13.

The search key input device 11 is for example a touch panel, a mouse, a keyboard, and/or an electronic blackboard. The search key input device 11 receives input of a search key. The search key is for example a word such as a keyword, a literature name, an URL, a sentence, and/or an image. That is, the search key is not limited to characters. In a case where the search key is an image, the search key is input through an electronic blackboard, for example. Examples of the image include: a single image; a combination of images; an uncompleted image; information indicating a relationship between images such as an arrow disposed between the images; and information indicating grouping of images.

The search key input device 11 may include a voice input device. The voice input device includes an input section such as a microphone and a processing section. The processing section includes a processor such as a central processing unit (CPU) or a micro processing unit (MPU). The processor of the processing section controls the input section through execution of a specific voice input program. The processing section converts voice sound of the meeting that has been input through the input section to character data (text data). The processing section then extracts a keyword from the character data. The processing section extracts the keyword by morphological analysis, for example. The keyword extracted by the processing section serves as the search key. Accordingly, in a configuration in which the search key input device 11 is constituted by a voice input device, the search key can be smoothly extracted from the voice sound of the meeting without human involvement.

The first storage 12 includes a first storage device. The first storage device includes a main storage device (for example, semiconductor memory) such as a read only memory (ROM) device or a random access memory (RAM) device, and may further include an auxiliary storage device (for example, a hard disk drive). The main storage device and/or the auxiliary storage device store(s) therein various computer programs to be executed by the selection section 13.

The first storage 12 stores therein search information 12a including a plurality of images and one or more search keys. The search information 12a is information that associates at least one search key with a stored image. Each of the plurality of stored images has at least one search key associated therewith in the search information 12a. In other words, the same search key may be associated with a plurality of stored images in the search information 12a. The stored images are for example images included in meeting information and/or images anticipated from the meeting information. The meeting information is information including a theme to be discussed in the meeting. The meeting information is included in a meeting material, for example. A facilitator for example prepares the search information 12a beforehand and causes the search information 12a to be stored in the first storage 12. Note that the stored images may include photographs of the meeting participants and/or images representing avatars of the meeting participants.

The selection section 13 includes a processor such as a central processing unit (CPU) or a micro processing unit (MPU). The selection section 13 controls each element of the image selection section 10 and the first communication section 30. Specifically, the processor of the selection section 13 controls the search key input device 11, the first storage 12, and the first communication section 30 through execution of the computer programs stored in the first storage device.

When a sentence is input to the search key input device 11, the selection section 13 extracts a keyword from the text. The keyword extracted by the selection section 13 serves as the search key. That is, the search key input device 11 receives not only input of a word but also input of a sentence. When a text is input to the search key input device 11 for example, the selection section 13 first performs morphological analysis on the text input to the search key input device 11. In the morphological analysis, the text is divided into words (morphemes) as minimum units having meanings, and parts of speech of the respective words are determined on the basis of a specific database. The selection section 13 then extracts a word of a specific part of speech as the keyword. Note that the facilitator can set a desired part of speech as the specific part of speech.

The selection section 13 selects the candidate images M from the stored images on the basis of the search key input to the search key input device 11 and the search information 12a. For example, the selection section 13 selects as the candidate images

M stored images associated with the search key input to the search key input device 11 in the search information 12a. One or more search keys may be input to the search key input device 11. The candidate images M are images to be objects of voting by the meeting participants.

Note that the selection section 13 for example compares the search key input to the search key input device 11 with search keys respectively associated with the stored images. The selection section 13 may select as the candidate images M stored images associated with search keys that are highly relevant to the search key input to the search key input device 11. Alternatively, the selection section 13 may select as the candidate images M a specific number of stored images that have high evaluation points in evaluation with a scalar evaluation function from among the stored images. Alternatively, the selection section 13 may select as the candidate images M stored images that have highly evaluated elements from among the stored images. The elements are elements of a vector evaluation function based on specific evaluation standpoints. Examples of vector elements include concrete, abstract, and emotional. Note that the facilitator may select two or more candidate images M from among the candidate images M selected by the selection section 13 and the two or more candidate images M selected by the facilitator may be determined as objects of voting by the meeting participants.

The meeting assist system 1 further includes a plurality of vote devices Y.

Each of the vote devices Y is an operation device for casting a vote for any of the candidate images M. The vote devices Y are respectively held by the meeting participants. The meeting participants cast votes for the candidate images M by operating the respective vote devices Y.

Each of the vote devices Y is for example a terminal such as a smartphone or a personal computer (PC).

In the first embodiment, the vote devices Y include first through N-th vote devices Y1 to YN. N represents an integer of 2 or greater. The first through N-th vote devices Y1 to YN have configurations similar to one another. The following describes the first vote device Y1.

The first vote device Y1 includes a display device 41, a switch operation device 42, a vote operation device 43, second storage 44, a controller 45, and a second communication section 46.

The display device 41 is a display such as a liquid crystal display (LCD) or an electroluminescent display (ELD). The display device 41 displays various information. The display device 41 may be a touch panel.

The display device 41 is capable of displaying a vote reception screen G1 and a vote input screen G2.

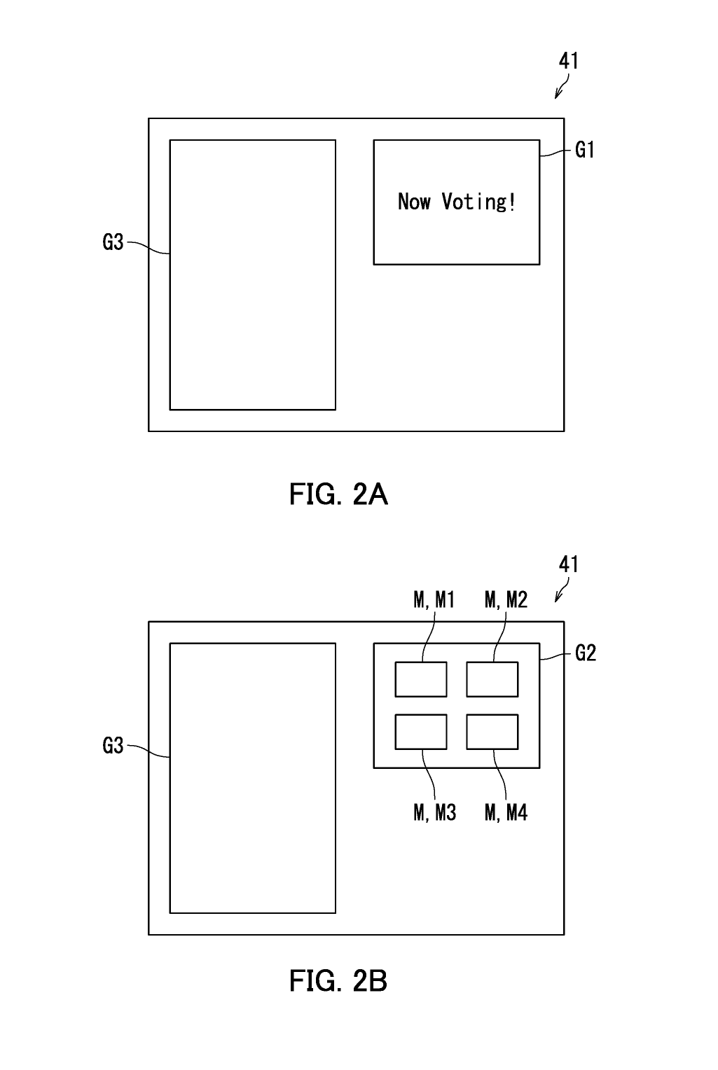

The following describes the display device 41 with reference to FIGS. 2A and 2B. FIG. 2A is a first diagram illustrating the vote reception screen G1. FIG. 2B is a first diagram illustrating the vote input screen G2.

As illustrated in FIG. 2A, an image that represents information indicating that voting is being carried out is displayed on the vote reception screen G1. In the first embodiment, “Now Voting!” is displayed on the vote reception screen G1.

As illustrated in FIG. 2B, the candidate images M are displayed on the vote input screen G2. In the first embodiment, the selection section 13 selects four candidate images M (first through fourth candidate images M1 to M4). Accordingly, the first through fourth candidate images M1 to M4 are displayed on the vote input screen G2.

As illustrated in FIGS. 1 to 2B, the switch operation device 42 is an operation device for switching a screen displayed by the display device 41 from the vote reception screen G1 to the vote input screen G2. The switch operation device 42 is an input device such as a mouse or a touch panel. In a case where the switch operation device 42 is a mouse, the vote reception screen G1 is switched to the vote input screen G2 when the meeting participant clicks on the vote reception screen G1 with the mouse, for example. In a case where the switch operation device 42 is a touch panel, the vote reception screen G1 is switched to the vote input screen G2 when the meeting participant touches the vote reception screen G1. The vote reception screen G1 being switched to the vote input screen G2 means that the vote reception screen G1 disappears and the vote input screen G2 is displayed at a place where the vote reception screen G1 had been displayed. Note that the switch operation device 42 may be constituted by a keyboard and/or a voice input device, and the screen displayed by the display device 41 may be switched from the vote reception screen G1 to the vote input screen G2 in response to an operation performed on the keyboard and/or the voice input device. The voice input device is for example a device for inputting information to an apparatus with voice. The voice input device includes a microphone, for example.

The vote operation device 43 is an operation device that receives input of a vote for any of the candidate images M. Input of a vote for any of the candidate images M refers to casting of a vote for a desired candidate image M among the candidate images M. Specifically, input of a vote for any of the candidate images M refers to selection of the desired candidate image M from among the candidate images M by the meeting participant and input of information indicating the desired candidate image M. The desired candidate image M is an image among the candidate images M that the meeting participant wants to use as the meeting image. The meeting participant can select an image or two or more images each as the desired candidate image M.

In the first embodiment, the vote operation device 43 receives input of a vote for any of the candidate images M while the vote input screen G2 is displayed. The vote operation device 43 is an input device such as a mouse or a touch panel. In a case where the vote operation device 43 is a mouse, the meeting participant casts a vote for the desired candidate image M among the first through fourth candidate images M1 to M4 displayed on the vote input screen G2 by clicking on the desired candidate image M with the mouse, for example. In a case where the vote operation device 43 is a touch panel, the meeting participant casts a vote for the desired candidate image M among the first through fourth candidate images M1 to M4 displayed on the vote input screen G2 by touching the desired candidate image M.

Note that the meeting participant may cast a vote for a single candidate image M among the candidate images M. Alternatively, the meeting participant may cast votes for two or more candidate images M among the candidate images M. Also, the vote operation device 43 may be constituted by a keyboard and/or a voice input device, and the vote for any of the candidate images M may be input through the keyboard and/or the voice input device. Also, the vote operation device 43 and the switch operation device 42 may be the same operation device. That is, the vote operation device 43 may function as the switch operation device 42.

The second storage 44 includes a second storage device. The second storage device includes a main storage device (for example, semiconductor memory) such as a read only memory (ROM) device or a random access memory (RAM) device, and may further include an auxiliary storage device (for example, a hard disk drive). The main storage device and/or the auxiliary storage device store(s) therein various computer programs to be executed by the controller 45.

The controller 45 includes a processor such as a central processing unit (CPU) or a micro processing unit (MPU). The controller 45 controls each element of the first vote device Y1. Specifically, the processor of the controller 45 controls the display device 41, the switch operation device 42, the vote operation device 43, and the second storage 44 through execution of the computer programs stored in the second storage device.

The following describes the first communication section 30 of the information processing device X and the second communication section 46 of each of the vote devices Y.

The information processing device X is connected to each of the vote devices Y wirelessly or by wire. Specifically, the first communication section 30 of the information processing device X is connected to the second communication section 46 of each vote device Y wirelessly or by wire. Therefore, various information can be transmitted between the information processing device X and each vote device Y. In a case where the information processing device X is connected to each vote device Y by wire for example, the first communication section 30 and the second communication section 46 each include a transceiver circuit and wiring. In such a case, the information processing device X and each vote device Y transmit various information to each other through the wiring. In a case where the information processing device X is connected to each vote device Y wirelessly for example, the first communication section 30 and the second communication section 46 each include a transceiver circuit and an antenna. In such a case, the information processing device X and each vote device Y transmit various information to each other through the antenna and a network such as a local area network (LAN).

The information processing device X further includes an image determination section 20.

The image determination section 20 includes a processor such as a central processing unit (CPU) or a micro processing unit (MPU). The image determination section 20 controls the first communication section 30. Specifically, the processor of the image determination section 20 controls the first communication section 30 through execution of a specific computer program. The image determination section 20 includes a calculation section 21 and a determination section 22. Specifically, the processor of the image determination section 20 functions as the calculation section 21 and the determination section 22 through execution of specific computer programs. Note that the image determination section 20 may be integrated with the selection section 13 of the image selection section 10. That is, the image determination section 20 may function as the selection section 13. The specific computer programs are stored in the first storage 12, for example.

The calculation section 21 calculates rankings of the numbers of votes cast for the respective candidate images M on the basis of a result of voting on the candidate images M. Specifically, the calculation section 21 receives information indicating a voted candidate image M among the candidate images M from a vote device Y that has received input of a vote. The calculation section 21 then calculates the numbers of votes cast for the respective candidate images M from the result of voting. The calculation section 21 then calculates the rankings of the numbers of votes cast for the respective candidate images M on the basis of the numbers of votes calculated for the respective candidate images M.

The determination section 22 determines the meeting image from among the candidate images M on the basis of the rankings of the numbers of votes cast for the respective candidate images M. The determination section 22 determines for example a candidate image M of the first ranking among the candidate images M as the meeting image. Note that the determination section 22 may determine two or more candidate images M of higher rankings among the candidate images M each as the meeting image. That is, the determination section 22 determines one or more meeting images from among the candidate images M on the basis of the rankings of the numbers of votes cast for the respective candidate images M.

The meeting assist system 1 further includes a meeting image display device Z. The meeting image display device Z is a display such as a liquid crystal display (LCD) or an electroluminescent display (ELD). The meeting image display device Z may be an electronic blackboard. The meeting image display device Z displays the meeting image. The meeting image display device Z is disposed such that the meeting participants can see the meeting image display device Z. Therefore, the meeting participants can see the meeting image displayed by the meeting image display device Z during the meeting. The meeting image display device Z is connected to the determination section 22. The meeting image display device Z receives information indicating the meeting image from the determination section 22. The meeting image display device Z then displays the meeting image.

As described above with reference to FIGS. 1 to 2B, the image determination section 20 determines at least one image among the candidate images M as the meeting image on the basis of the result of voting. Therefore, opinions of the meeting participants can be reflected to determination of the meeting image through voting by the meeting participants.

Also, whether or not each of the candidate images M is suitable as the meeting image is determined through voting. As a result, an image reflecting contents of the meeting can be determined as the meeting image.

Also, the selection section 13 selects the candidate images M from among the stored images on the basis of the search key and the search information 12a. Therefore, images to be selected as the candidate images M can be limited to images that are relevant to the contents of the meeting. As a result, processing for determining the meeting image from among the candidate images M can be executed smoothly.

Also, the calculation section 21 calculates the rankings of the numbers of votes cast for the respective candidate images M on the basis of the result of voting on the candidate images M. The determination section 22 then determines the meeting image from among the candidate images M on the basis of the rankings. Therefore, opinions of the meeting participants can be effectively reflected to determination of the meeting image.

Also, the screen displayed by the display device 41 can be switched between the vote reception screen G1 and the vote input screen G2 through the switch operation device 42. Therefore, it is possible to notify the meeting participant of voting being carried out and to receive input of a vote from the meeting participant.

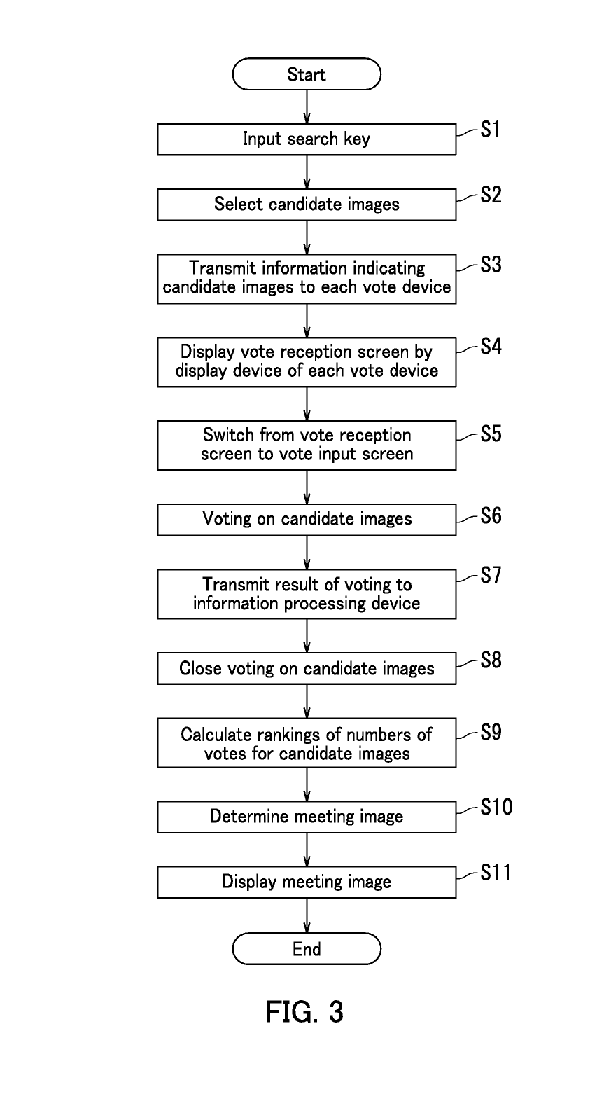

The following describes a process for determining the meeting image by the meeting assist system 1 with reference to FIG. 3. FIG. 3 is a first flowchart illustrating the process for determining the meeting image by the meeting assist system 1.

As illustrated in FIG. 3, the search key input device 11 receives input of one or more search keys at Step S1. In the first embodiment, the facilitator inputs the one or more search keys to the search key input device 11. In the first embodiment, the facilitator inputs the search key(s) while the meeting is carried out or by temporarily suspending the meeting. In the first embodiment, the facilitator subjectively determines each of the search key(s) to be input to the search key input device 11. The facilitator determines the search key for example on the basis of contents of a discussion in the meeting. The facilitator determines for example a word mainly used in the meeting as the search key.

At Step S2, the image selection section 10 selects a plurality of candidate images M. Specifically, the selection section 13 selects the candidate images M from among a plurality of stored images on the basis of the search key(s) input to the search key input device 11 and the search information 12a.

At Step S3, the information processing device X transmits information indicating the candidate images M to each of the vote devices Y. Specifically, the selection section 13 of the information processing device X controls the first communication section 30 so that the first communication section 30 transmits the information indicating the candidate images M to the second communication section 46 of each vote device Y. As a result, each vote device Y receives the information indicating the candidate images M.

At Step S4, upon reception of the information indicating the candidate images M by the second communication section 46 of each vote device Y, the display device 41 of the vote device Y displays the vote reception screen G1. Specifically, upon reception of the information indicating the candidate images M by the second communication section 46 of each vote device Y, the controller 45 of the vote device Y controls the display device 41 so that the display device 41 displays the vote reception screen G1.

At Step S5, the controller 45 controls the display device 41 so that the vote reception screen G1 is switched to the vote input screen G2 in response to a specific operation performed on the switch operation device 42. That is, the meeting participant switches the vote reception screen G1 to the vote input screen G2 by operating the switch operation device 42.

At Step S6, the vote operation device 43 receives input of a vote for any of the candidate images M. That is, a vote is cast for any of the candidate images M. The meeting participant casts a vote for a desired candidate image M.

At Step S7, the vote device Y among the vote devices Y that has received input of the vote transmits information indicating a result of voting to the information processing device X. Specifically, the controller 45 of the vote device Y that has received input of the vote controls the second communication section 46 thereof so that the second communication section 46 transmits the information indicating the result of voting to the first communication section 30. As a result, the first communication section 30 receives the information indicating the result of voting on the candidate images M. The information indicating the result of voting is in other words information indicating the voted candidate image M among the candidate images M.

At Step S8, the vote device Y closes voting on the candidate images M. Specifically, the controller 45 of the vote device Y closes voting on the candidate images M. Voting is closed for example when a specific period has elapsed after display of the vote reception screen G1 by the display device 41. In this case, termination information indicating that voting on the candidate images M is closed is displayed by the display device 41, for example. The controller 45 controls the display device 41 so that the display device 41 displays the termination information when the specific period has elapsed after display of the vote reception screen G1 by the display device 41. The controller 45 for example has a timer function to measure the specific period. Note that voting may be closed when the specific period has elapsed after display of the vote reception screen G1 by the display device 41 or when all vote devices Y have received input of votes. Alternatively, the facilitator may close voting on the candidate images M by manually operating an operation device. That is, the facilitator may determine a desired timing at which voting on the candidate images M is to be closed.

At Step S9, the calculation section 21 of the image determination section 20 calculates the numbers of votes cast for the respective candidate images M from the result of voting. The calculation section 21 then calculates rankings of the numbers of votes cast for the respective candidate images M on the basis of the calculated numbers of votes.

At Step S10, the determination section 22 determines a meeting image from among the candidate images M on the basis of the rankings of the numbers of votes cast for the respective candidate images M.

At Step S11, the determination section 22 controls the meeting image display device Z so that the meeting image display device Z displays the meeting image. As a result, the meeting image display device Z displays the meeting image. When the meeting image is displayed by the meeting image display device Z, the meeting participants can see the meeting image on the meeting image display device Z and deepen their understanding of contents of the meeting to progress the meeting.

### Second Embodiment

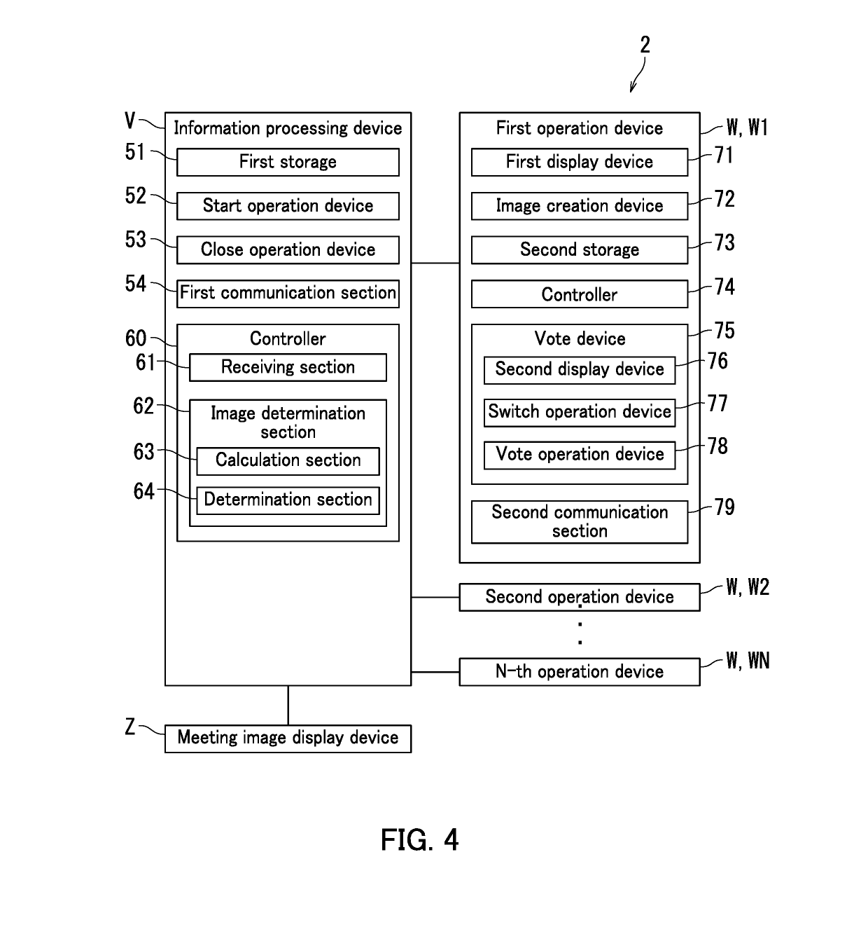

The following describes a meeting assist system 2 according to the second embodiment of the present disclosure with reference to FIG. 4. FIG. 4 is a block diagram illustrating the meeting assist system 2 according to the second embodiment of the present disclosure.

The meeting assist system 2 illustrated in FIG. 4 is used for a meeting adopting the graphic recording, for example.

The meeting assist system 2 determines a meeting image. In the second embodiment, the meeting assist system 2 determines the meeting image from among application images P created by the meeting participants.

The meeting assist system 2 includes an information processing device V. The information processing device V invites proposals for the meeting image and determines the meeting image from among a plurality of application images P submitted in response to the invitation.

The information processing device V includes first storage 51, a start operation device 52, a close operation device 53, a first communication section 54, and a controller 60.

The first storage 51 includes a first storage device. The first storage device includes a main storage device such as a ROM device or a RAM device, and may further include an auxiliary storage device. The main storage device and/or the auxiliary storage device store(s) therein various computer programs to be executed by an image determination section 62.

The controller 60 includes a processor such as a CPU or an MPU. The controller 60 controls each element of the information processing device V. Specifically, the processor of the controller 60 controls the first storage 51, the start operation device 52, the close operation device 53, and the first communication section 54 through execution of specific computer programs. The controller 60 includes a receiving section 61 and the image determination section 62. Specifically, the processor of the controller 60 functions as the receiving section 61 and the image determination section 62 through execution of specific computer programs.

The receiving section 61 receives proposals for the meeting image made in response to invitation for the proposals. Receiving an application refers to acquiring information indicating an application image P. In the second embodiment, the application images P are respectively submitted to the receiving section 61 through a plurality of operation devices W. In the second embodiment, the meeting is suspended while the receiving section 61 is receiving the proposals. That is, the proposals are received by the receiving section 61 during a specific application period in which the meeting is suspended.

In the second embodiment, the facilitator determines a timing at which the meeting is to be suspended, a timing at which the specific application period is to be started, and a timing at which the specific application period is to be ended.

The start operation device 52 is an operation device that receives input of start information. The start information is information indicating that reception of the proposals for the meeting image is to be started. In response to input of the start information to the start operation device 52, the receiving section 61 starts to receive the proposals. The start operation device 52 is a touch panel, for example.

The close operation device 53 is an operation device that receives input of close information. The close information is information indicating that reception of the proposals for the meeting image is to be closed. In response to input of the close information to the close operation device 53, the receiving section 61 closes reception of the proposals. The close operation device 53 is a touch panel, for example. Note that the start operation device 52 may function as the close operation device 53. That is, the start operation device 52 and the close operation device 53 may be the same operation device.

When the specific application period ends, the receiving section 61 transmits information indicating the application images P acquired during the specific application period to each of the operation devices W. The specific application period in the second embodiment is a period from when the start information is input to the start operation device 52 to when the close information is input to the close operation device 53. Then, votes are cast for the application images P through the operation devices W.

The image determination section 62 determines the meeting image from among the application images P. In the second embodiment, the image determination section 62 determines the meeting image from among the application images P on the basis of a result of voting. The image determination section 62 will be described later in detail.

The meeting assist system 2 further includes the plurality of operation devices W.

Each of the operation devices W is a device for creating an application image P. The operation devices W are respectively held by the meeting participants. The meeting participants respectively create the application images P by operating the operation devices W.

Each of the operation devices W is for example a terminal such as a smartphone or a PC.

In the second embodiment, the operation devices W include first through N-th operation devices W1 to WN. N represents an integer of 2 or greater. The first through N-th operation devices W1 to WN have configurations similar to one another. The following describes the first operation device W1.

The first operation device W1 includes a first display device 71, an image creation device 72, second storage 73, a controller 74, a vote device 75, and a second communication section (communication section) 79.

The first display device 71 is for example a display such as an LCD or an ELD. The first display device 71 may be a touch panel. The first display device 71 is capable of displaying an application screen. The first display device 71 displays the application screen during the specific application period. An image that represents information indicating that submission of the application images P is being accepted is displayed on the application screen. In the second embodiment, “Submission of illustrations is being accepted!” is displayed on the application screen.

The image creation device 72 is a device for creating the application image P. The image creation device 72 includes for example an input device, image creation software, and hardware that executes the image creation software. The input device is for example a mouse, a stylus, and/or a touch panel. The application image P is created by the image creation software in response to an operation performed through the input device by the meeting participant. The created application image P is displayed by the first display device 71, for example. Note that the meeting participant may retrieve an image on the Internet and determine the retrieved image as the application image P. Alternatively, the meeting participant may draw the application image P on a sheet T by hand. In this case, the meeting participant for example causes a scanner to read the handwritten application image P or digitizes the application image P by capturing the handwritten application image P with a digital camera. Information indicating the application image P created through the image creation device 72 is transmitted to the receiving section 61 of the information processing device V. That is, the application image P is submitted in response to invitation for the proposals for the meeting image. Note that a specific icon and the application image P created by the meeting participant may be displayed by the first display device 71, and the information indicating the application image P may be transmitted to the receiving section 61 in response to the application image P being moved onto the specific icon by a drag-and-drop operation.

The second storage 73 includes a second storage device. The second storage device includes a main storage device such as a ROM device or a RAM device, and may further include an auxiliary storage device. The main storage device and/or the auxiliary storage device store(s) therein various computer programs to be executed by the controller 74.

The controller 74 includes a processor such as a CPU or an MPU. The controller 74 controls each element of the first operation device W1. Specifically, the processor of the controller 74 controls the image creation device 72, the second storage 73, the vote device 75, and the second communication section 79 through execution of the computer programs stored in the second storage device.

The vote device 75 is an operation device for casting a vote for any of the application images P. Through the vote device 75, the vote is cast for any of the application images P submitted during the specific application period. The vote device 75 includes a second display device 76, a switch operation device 77, and a vote operation device 78.

The second display device 76 is for example a display such as an LCD or an ELD. The second display device 76 displays various information. The second display device 76 may be a touch panel.

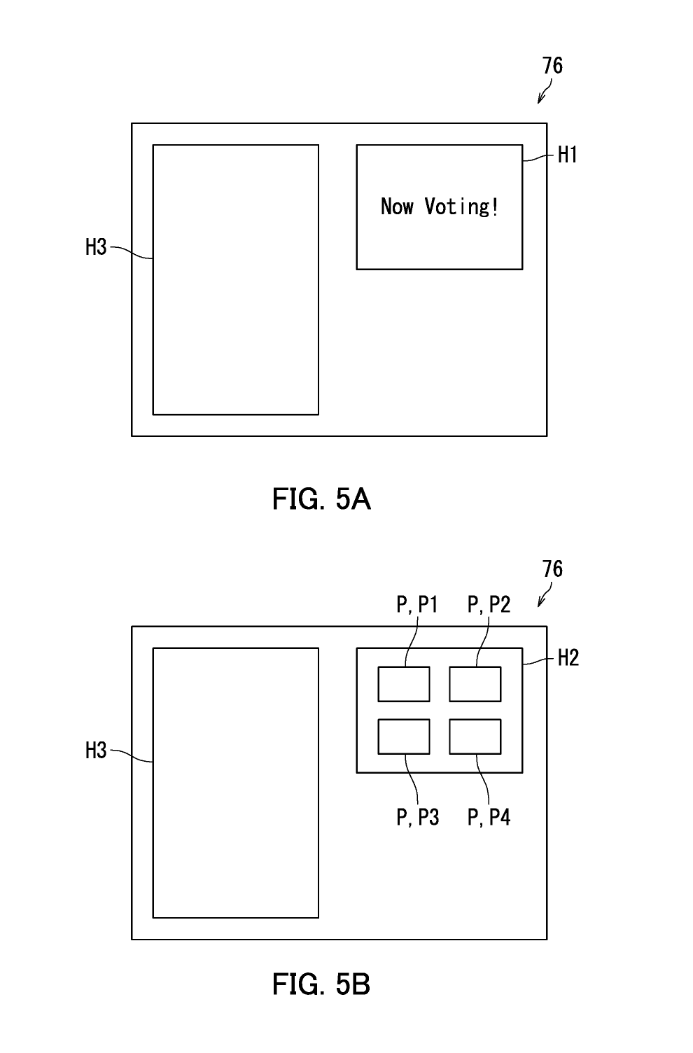

The second display device 76 is capable of displaying a vote reception screen H1 and a vote input screen H2. The following describes the second display device 76 with reference to FIGS. 5A and 5B. FIG. 5A is a second diagram illustrating the vote reception screen H1. FIG. 5B is a second diagram illustrating the vote input screen H2.

As illustrated in FIG. 5A, the vote reception screen H1 is a screen that displays information indicating that voting on the application images P is being carried out. In the second embodiment, “Now Voting!” is displayed on the vote reception screen H1.

As illustrated in FIG. 5B, the vote input screen H2 is a screen that displays the information indicating the application images P. In the second embodiment, the application images P are displayed on the vote input screen H2. In the second embodiment, four application images P (first through fourth application images P1 to P4) are submitted. Accordingly, the first through fourth application images P1 to P4 are displayed on the vote input screen H2. Note that the second display device 76 and the first display device 71 may be the same display device. That is, the first display device 71 may function as the second display device 76.

As illustrated in FIGS. 4 to 5B, the switch operation device 77 is an operation device for switching a screen displayed by the second display device 76 from the vote reception screen H1 to the vote input screen H2. The switch operation device 77 is an input device such as a mouse or a touch panel. The switch operation device 77 has the same configuration as that of the switch operation device 42 of the first embodiment.

The vote operation device 78 is an operation device that receives input of a vote for any of the application images P. Input of a vote for any of the application images P refers to casting of a vote for a desired application image P among the application images P. Specifically, input of a vote for any of the application images P refers to selection of the desired application image P from among the application images P by the meeting participant and input of information indicating the desired application image P. The desired application image P is an image among the application images P that the meeting participant wants to use as the meeting image. The meeting participant can select an image or two or more images each as the desired application image P. In the second embodiment, the vote operation device 78 receives input of a vote for any of the application images P while the vote input screen H2 is displayed.

The vote operation device 78 is an input device such as a mouse or a touch panel. The vote operation device 78 has a configuration similar to that of the vote operation device 43 of the first embodiment.

Note that the meeting participant may cast a vote for a single application image P among the application images P. Alternatively, the meeting participant may cast votes for two or more application images P among the application images P. Also, the vote operation device 78 and the switch operation device 77 may be the same operation device. That is, the vote operation device 78 may function as the switch operation device 77.

The following describes the first communication section 54 of the information processing device V and the second communication section 79 of each of the operation devices W.

The information processing device V is connected to each of the operation devices W wirelessly or by wire. Specifically, the first communication section 54 of the information processing device V is connected to the second communication section 79 of each operation device W wirelessly or by wire. Therefore, various information can be transmitted between the information processing device V and each operation device W. In a case where the information processing device V is connected to each operation device W by wire for example, the first communication section 54 and the second communication section 79 each include a transceiver circuit and wiring. In such a case, the information processing device V and each operation device W transmit various information to each other through the wiring. In a case where the information processing device V is connected to each operation device W wirelessly, the first communication section 54 and the second communication section 79 each include a transceiver circuit and an antenna. In such a case, the information processing device V and each operation device W transmit various information to each other through the antenna and a network such as a LAN.

The following describes the image determination section 62 of the information processing device V.

The image determination section 62 includes a calculation section 63 and a determination section 64.

The calculation section 63 calculates rankings of the numbers of votes cast for the respective application images P on the basis of a result of voting on the application images P. Specifically, the calculation section 63 receives information indicating a voted application image P among the application images P from an operation device W that has received input of a vote. The calculation section 63 then calculates the numbers of votes cast for the respective application images P from the result of voting. The calculation section 63 then calculates the rankings of the numbers of votes cast for the respective application images P on the basis of the numbers of votes calculated for the respective application images P.

The determination section 64 determines the meeting image from among the application images P on the basis of the rankings of the numbers of votes cast for the respective application images P. The determination section 64 determines for example an application image P of the first ranking among the application images P as the meeting image. Note that the determination section 64 may determine two or more application images P of higher rankings among the application images P each as the meeting image. That is, the determination section 64 determines one or more meeting images from among the application images P on the basis of the rankings of the numbers of votes cast for the respective application images P.

The meeting assist system 2 further includes a meeting image display device Z.

The meeting image display device Z is connected to the determination section 64. The meeting image display device Z receives information indicating the meeting image from the determination section 64. The meeting image display device Z then displays the meeting image.

As described above with reference to FIGS. 4 to 5B, the image determination section 62 determines at least one image among the application images P submitted through the receiving section 61 as the meeting image. Therefore, opinions of the meeting participants can be reflected to determination of the meeting image through reception of the proposals for the meeting image from the meeting participants.

Also, the image determination section 62 determines at least one image among the application images P as the meeting image on the basis of the result of voting on the application images P. Therefore, opinions of the meeting participants can be effectively reflected to determination of the meeting image through voting by the meeting participants. Also, whether or not each of the application images P is suitable as the meeting image is determined through voting. As a result, an image reflecting contents of the meeting can be determined as the meeting image.

Also, the calculation section 63 calculates the rankings of the numbers of votes cast for the respective application images P on the basis of the result of voting on the application images P. The determination section 64 then determines the meeting image from among the application images P on the basis of the rankings. Therefore, opinions of the meeting participants can be reflected to determination of the meeting image.

Further, the meeting assist system 2 includes the image creation device 72 for creating the application image P. Therefore, the meeting participant can create the application image P through the image creation device 72. As a result, an opinion of the meeting participant can be reflected to determination of the meeting image.

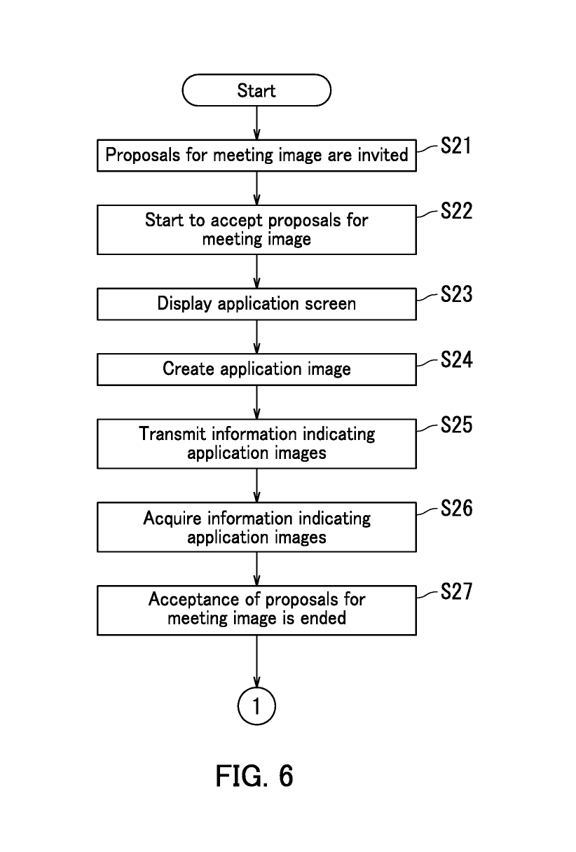

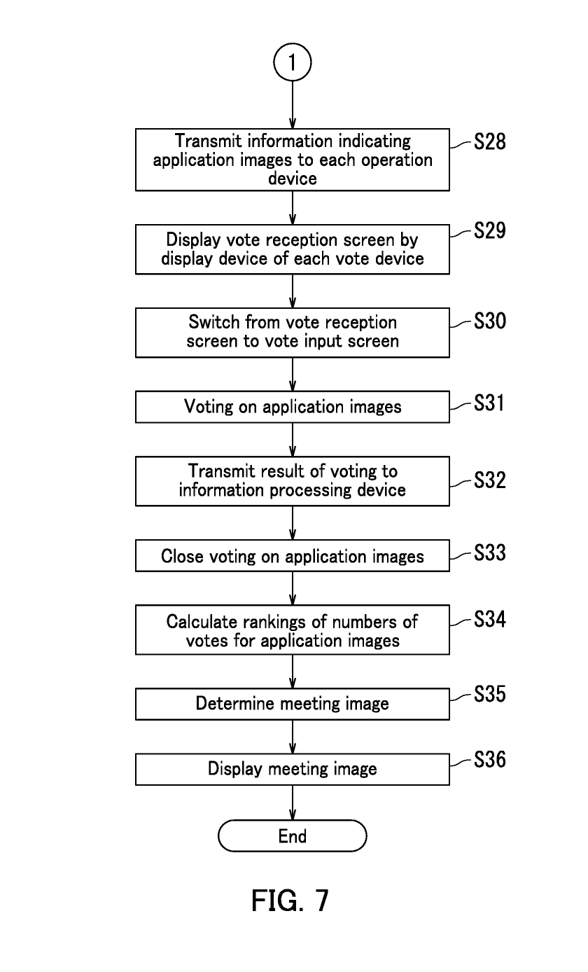

The following describes a process for determining the meeting image by the meeting assist system 2 with reference to FIGS. 6 and 7. FIG. 6 is a second flowchart illustrating the process for determining the meeting image by the meeting assist system 2. FIG. 7 is a third flowchart illustrating the process for determining the meeting image by the meeting assist system 2.

As illustrated in FIG. 6, the start operation device 52 receives input of the start information at Step S21. That is, the meeting is suspended and the meeting participants are invited to make proposals for the meeting image. The start operation device 52 receives input of the start information upon suspension of the meeting.

At Step S22, the receiving section 61 starts to accept proposals for the meeting image made in response to invitation for the proposals.

At Step S23, the controller 74 controls the first display device 71 so that the first display device 71 displays the application screen. Note that the application screen is displayed by the first display device 71 of each of the operation devices W.

At Step S24, an application image P is created through the image creation device 72. Note that application images P are respectively created through the operation devices W. In the second embodiment, the meeting participants create the application images P while the meeting is suspended. Therefore, the meeting participants can create the application images P, keeping contents of the meeting clearly in their mind.

At Step S25, the controller 74 controls the second communication section 79 so that information indicating the application image P is transmitted to the receiving section 61. Note that the information indicating the application image P is transmitted to the receiving section 61 through the second communication section 79 and the first communication section 54. The operation devices W respectively transmit information indicating the application images P. Accordingly, the information indicating the application images P is transmitted to the receiving section 61. As a result, the receiving section 61 receives the information indicating the application images P.

At Step S26, the receiving section 61 acquires the information indicating the application images P.

At Step S27, the close operation device 53 receives input of the close information. That is, acceptance of proposals for the meeting image is ended.

As illustrated in FIG. 7, the receiving section 61 transmits the information indicating the application images P received during the specific application period to each of the operation devices W at Step S28. Specifically, the receiving section 61 controls the first communication section 54 so that the information indicating the application images P is transmitted to the second communication section 79 of each operation device W. As a result, each operation device W receives the information indicating the application images P.

At Step S29, upon reception of the information indicating the application images P by the second communication section 79 of each operation device W, the second display device 76 of the operation device W displays the vote reception screen H1. Specifically, upon reception of the information indicating the application images P by the second communication section 79 of each operation device W, the controller 74 of the operation device W controls the second display device 76 so that the second display device 76 displays the vote reception screen H1.

At Step S30, the controller 74 controls the second display device 76 so that the vote reception screen H1 is switched to the vote input screen H2 in response to a specific operation performed on the switch operation device 77. That is, the meeting participant switches the vote reception screen H1 to the vote input screen H2 by operating the switch operation device 77.

At Step S31, the vote operation device 78 receives input of a vote for any of the application images P. That is, a vote is cast for any of the application images P. The meeting participant casts a vote for a desired application image P.

At Step S32, the operation device W among the operation devices W that has received input of the vote transmits information indicating a result of voting to the information processing device V. The information indicating the result of voting is transmitted from the second communication section 79 to the first communication section 54. As a result, the first communication section 54 receives the information indicating the result of voting on the application images P. The information indicating the result of voting is in other words information indicating the voted application image P among the application images P.

At Step S33, the operation device W closes voting on the application images P. Specifically, the controller 74 of the operation device W closes voting on the application images P. Voting is closed for example when a specific period has elapsed after display of the vote reception screen H1 by the second display device 76. In this case, termination information indicating that voting on the application images P is closed is displayed by the second display device 76, for example. The controller 74 controls the second display device 76 so that the second display device 76 displays the termination information when the specific period has elapsed after display of the vote reception screen H1 by the second display device 76. The controller 74 has a timer function to measure the specific period, for example.

Note that voting may be closed when the specific period has elapsed after display of the vote reception screen H1 by the second display device 76 or when all operation devices W have received input of votes. Alternatively, the facilitator may close voting on the application images P by manually operating an operation device. That is, the facilitator may determine a desired timing at which voting on the application images P is to be closed.

At Step S34, the calculation section 63 of the image determination section 62 calculates the numbers of votes cast for the respective application images P from the result of voting. The calculation section 63 then calculates rankings of the numbers of votes cast for the respective application images P on the basis of the calculated numbers of votes.

At Step S35, the determination section 64 determines a meeting image from among the application images P on the basis of the rankings of the numbers of votes cast for the respective application images P.

At Step S36, the determination section 64 controls the meeting image display device Z so that the meeting image display device Z displays the meeting image. As a result, the meeting image display device Z displays the meeting image. When the meeting image is displayed by the meeting image display device Z, the meeting participants can see the meeting image on the meeting image display device Z and deepen their understanding of contents of the meeting to progress the meeting.

Note that in the second embodiment, Steps S21 to S36 are performed while the meeting is suspended. The meeting is resumed after the meeting image is displayed by the meeting image display device Z at Step S36.

### Third Embodiment

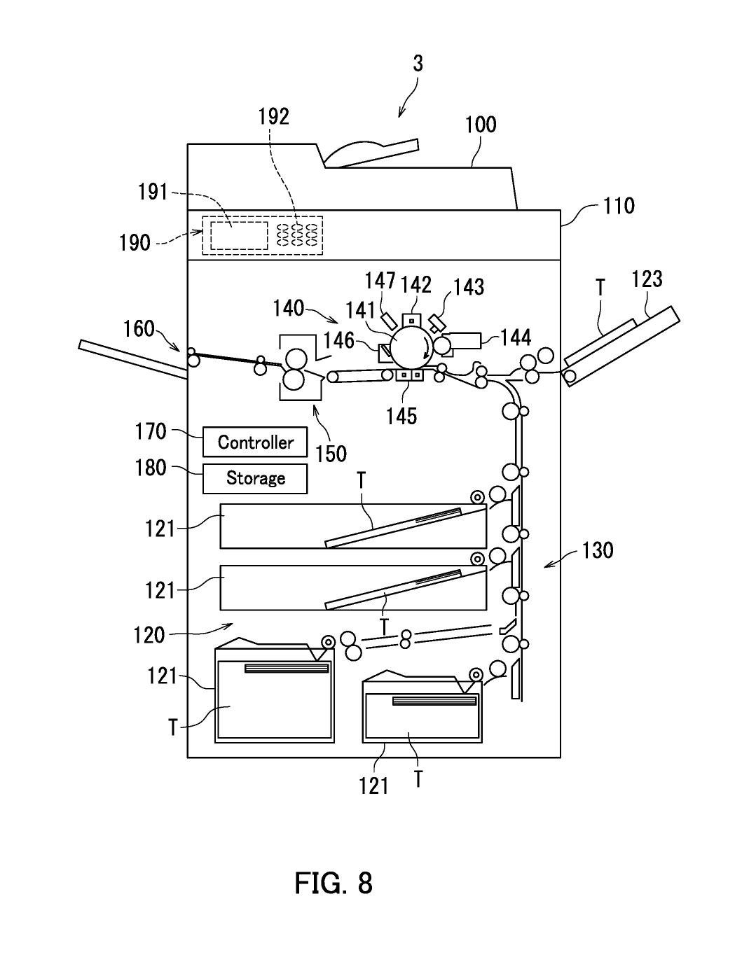

The following describes an image forming apparatus 3 with reference to FIG. 8. FIG. 8 is a schematic cross-sectional view of the image forming apparatus 3. The image forming apparatus 3 is for example a copier, a printer, a facsimile machine, or a multifunction peripheral. The multifunction peripheral includes for example at least two of a copier, a printer, and a facsimile machine.

As illustrated in FIG. 8, the image forming apparatus 3 includes a controller 170, storage 180, an input device 190, a document conveyance section 100, an image reading section 110, an accommodation section 120, a conveyance section 130, an image forming device 140, a fixing section 150, and an ejection section 160. A sheet T is conveyed along a sheet conveyance direction within the image forming apparatus 3.

The controller 170 functions as the selection section 13 and the image determination section 20 according to the first embodiment and the controller 60 according to the second embodiment. The storage 180 functions as the first storage 12 according to the first embodiment and the first storage 51 according to the second embodiment. The input device 190 functions as the search key input device 11 according to the first embodiment, the start operation device 52 and the close operation device 53 according to the second embodiment. Accordingly, the controller 170, the storage 180, and the input device 190 of the image forming apparatus 3 constitute the information processing device X according to the first embodiment and the information processing device V according to the second embodiment.

The input device 190 includes a display device 191 and a group of operation keys 192. The input device 190 receives an instruction from a user to the image forming apparatus 3. That is, the user inputs a job to the image forming apparatus 3 through the input device 190. The display device 191 may be a touch panel.

The document conveyance section 100 conveys a document to the image reading section 110. The image reading section 110 reads an image of the document to generate image data. The accommodation section 120 accommodates sheets T. The accommodation section 120 includes a cassette 121 and a manual feed tray 123. The sheets T are stacked in the cassette 121. A sheet T is fed from the cassette 121 or the manual feed tray 123 to the conveyance section 130. Examples of the sheet T include plain paper, copy paper, recycled paper, thin paper, thick paper, glossy paper, and an overhead projector (OHP) sheet.

The conveyance section 130 conveys the sheet T to the image forming device 140. The image forming device 140 includes a photosensitive drum 141, a charger 142, a light exposure section 143, a development section 144, a transfer section 145, a cleaner 146, and a static eliminator 147. The image forming device 140 forms (prints) an image on the sheet T. The image forming device 140 forms the meeting image on the sheet T.

The sheet T with the image formed thereon is conveyed to the fixing section 150. The fixing section 150 applies heat and pressure to the sheet T, thus fixing the image on the sheet T. The sheet T with the image fixed thereon is conveyed to the ejection section 160. The ejection section 160 ejects the sheet T.

The storage 180 includes a third storage device. The third storage device includes a main storage device (for example, semiconductor memory) such as a ROM device or a RAM device, and may further include an auxiliary storage device (for example, a hard disk drive). The main storage device and/or the auxiliary storage device store(s) therein various computer programs to be executed by the controller 170.

The controller 170 includes a processor such as a CPU or an MPU. The controller 170 controls each element of the image forming apparatus 3. Specifically, the processor of the controller 170 controls the document conveyance section 100, the image reading section 110, the accommodation section 120, the conveyance section 130, the image forming device 140, and the fixing section 150 through execution of the computer programs stored in the storage 180.

As described above with reference to FIG. 8, the image forming apparatus 3 functions as the information processing device X according to the first embodiment as well as the information processing device V according to the second embodiment. Therefore, similarly to the first and second embodiments, opinions of the meeting participants can be reflected to determination of the meeting image through use of the image forming apparatus 3 according to the third embodiment.

Through the above, the embodiments of the present disclosure have been described with reference to the drawings (FIGS. 1 to 8). However, the present disclosure is not limited to the above embodiments and can be practiced in various forms (for example, as described below in (1) to (9)) within a scope not departing from the gist of the present disclosure. Also, elements of configuration described in the above embodiments may be combined as appropriate to embody the present disclosure in various forms. For example, some elements of configuration among the all elements described in the above embodiments may be omitted. The drawings schematically illustrate elements of configuration in order to facilitate understanding. The numbers or the like of the elements of configuration illustrated in the drawings may differ from actual ones thereof in order to facilitate preparation of the drawings. Also, the elements of configuration described in the above embodiments are merely examples and should not be taken as specific limitations. Various alterations can be made within a scope not substantially departing from effects of the present disclosure.

(1) In the first and second embodiments, the meeting image is displayed by the meeting image display device Z. However, the present disclosure is not limited to this configuration. It is only required that the meeting image be displayed such that the meeting participants can see the meeting image. For example, the meeting image may be displayed by the display device 41 of the vote device Y in the first embodiment. Specifically, the meeting image may be displayed by the display device 41 of each of the vote devices Y. The meeting image may be displayed by the second display device 76 of the operation device W in the second embodiment. Specifically, the meeting image may be displayed by the second display device 76 of each of the operation devices W. In the above cases, the meeting image display device Z may be omitted. As a result, the meeting assist system 1 or 2 can have a simple configuration without a large-sized meeting image display device Z that can be seen by all meeting participants. Alternatively, the meeting image may be formed on sheets T and the sheets T with the meeting image formed thereon may be distributed to the meeting participants. In this case, the meeting image is formed on the sheets T by the image forming apparatus 3 according to the third embodiment, for example. In this case too, the meeting image display device Z may be omitted.

In a case where the meeting image is displayed by the display device 41 of each vote device Y as illustrated in FIGS. 2A and 2B in the first embodiment, a meeting image display screen G3 for displaying the meeting image may be provided on the display device 41. Further, the meeting image display screen G3 may be displayed together with the vote reception screen G1 or the vote input screen G2. That is, the meeting image display screen G3 and either the vote reception screen G1 or the vote input screen G2 may constitute a single screen. In this configuration, the meeting participant can cast a vote for any of the candidate images M while seeing the meeting image to participate the meeting.

In a case where the meeting image is displayed by the second display device 76 of each operation device W as illustrated in FIGS. 5A and 5B in the second embodiment, a meeting image display screen H3 for displaying the meeting image may be provided on the second display device 76. Further, the meeting image display screen H3 may be displayed together with the vote reception screen H1 or the vote input screen H2. That is, the meeting image display screen H3 and either the vote reception screen H1 or the vote input screen H2 may constitute a single screen. In this configuration, the meeting participant can cast a vote for any of the application images P while seeing the meeting image to participate the meeting.

(2) As illustrated in FIG. 3, the image selection section 10 selects the plurality of candidate images M at Step S2 in the first embodiment. However, the present disclosure is not limited to this configuration. The facilitator may select the candidate images M. For example, the facilitator may retrieve on the Internet a word mainly used in the meeting, and determine images found through the Internet search as the candidate images M. In this case, a retrieval device such as a PC to be used for the Internet search is connected to each vote device Y wirelessly or by wire, and information indicating the candidate images M selected through the Internet search is transmitted from the retrieval device to each vote device Y. The meeting participants then cast votes for the candidate images M through the respective vote devices Y.

Alternatively, the search key input device 11 may be constituted by an electronic blackboard and the facilitator may input the candidate images M on the electronic blackboard by handwriting. That is, the facilitator may create the candidate images M on the basis of contents of the meeting. Information indicating the candidate images M input by handwriting is transmitted from the electronic blackboard to each vote device Y. The meeting participants then cast votes for the candidate images M through the respective vote devices Y.

(3) In the first embodiment, the determination section 22 determines the meeting image from among the candidate images M on the basis of the rankings of the numbers of votes cast for the respective candidate images M. However, the present disclosure is not limited to this configuration. For example, the facilitator may determine the meeting image from among the candidate images M taking the rankings into account. As a result, an opinion of the facilitator can be reflected to determination of the meeting image. Also in the second embodiment, the facilitator may for example determine the meeting image from among the application images P taking the rankings into account.

(4) In the first embodiment, votes are cast for the candidate images M while the meeting is carried out. As a result, the meeting can be smoothly progressed. However, the present disclosure is not limited to this configuration. The meeting may be suspended while the votes are cast for the candidate images M. That is, the meeting may be suspended in the middle to conduct voting on the candidate images M. The meeting is resumed upon completion of the voting on the candidate images M. In this case, the meeting participants can focus on the voting without being distracted by progress of the meeting. Also in the second embodiment, the meeting may be suspended while votes are cast for the application images P. That is, the meeting may be suspended in the middle to conduct voting on the application images P.

(5) In the first embodiment, with respect to each of the candidate images M displayed on the vote input screen G2, a search key associated with the candidate image M and/or an evaluation point of the candidate image M calculated by an evaluation function may be displayed together with the candidate image M. In this configuration, the meeting participant can cast a vote for any of the candidate images M with reference to search keys associated with the respective candidate images M and/or evaluation points of the respective candidate images M calculated by the evaluation function.

(6) At Step S9 in FIG. 3 of the first embodiment, information indicating the rankings of the numbers of votes cast for the respective candidate images M calculated by the calculation section 21 may be stored in the first storage 12. Also, at Step S34 in FIG. 7 of the second embodiment, information indicating the rankings of the numbers of votes cast for the respective application images P calculated by the calculation section 63 may be stored in the first storage 51. That is, the information indicating the rankings may be stored as a minute of the meeting in the first and second embodiments. Additionally, in the first and second embodiments, not only the information indicating the rankings, but also vote information that associates a voted candidate image M or a voted application image P with one or more attributes of a person who has cast a vote for the candidate image M or the application image P may be stored together with the information indicating the rankings. Examples of attributes include age, sex, name, and job. In this case, for example when the meeting is reviewed on the basis of the minute after the meeting is finished, the meeting can be reviewed from various standpoints on the basis of the vote information. Further, in the first embodiment, the vote information that associates the voted candidate image M with the one or more attributes of the person who has cast a vote for the candidate image M may be displayed during the meeting by the meeting image display device Z and/or the display device 41 of each vote device Y. Also in the second embodiment, the vote information that associates the voted application image P with the one or more attributes of the person who has cast a vote for the application image P may be displayed during the meeting by the meeting image display device Z and/or the second display device 76 of each operation device W.

In the first embodiment, during or upon voting on the candidate images M, a comment may for example be input through the vote operation device 43. The comment is input by the meeting participant casting a vote. Note that information indicating the comment may be stored as a minute of the meeting in the first storage 12, on a server, or on a cloud. In this case, the information indicating the comment is stored as the minute of the meeting. Additionally or alternatively, the comment may be displayed during the meeting by the meeting image display device Z and/or the display device 41 of each vote device Y. In this configuration, the meeting participants can have a common view of the meeting, resulting in activation of discussions during the meeting.

Also in the second embodiment, during or upon voting on the application images P, a comment may for example be input through the vote operation device 78. The comment is input by the meeting participant casting a vote. Note that information indicating the comment may be stored as a minute of the meeting in the first storage 51, on a server, or on a cloud. In this case, the information indicating the comment is stored as the minute of the meeting. Additionally or alternatively, the comment may be displayed during the meeting by the meeting image display device Z and/or the second display device 76 of each operation device W. In this configuration, the meeting participants can have a common view of the meeting, resulting in activation of discussions during the meeting.

(7) In the first embodiment, the meeting participants cast votes for the candidate images M. However, the present disclosure is not limited to this configuration. The meeting participants and/or an audience of the meeting may cast votes for the candidate images M. In this case, the first communication section 30 receives information indicating a result of voting on the candidate images M performed by the meeting participants and/or the audience of the meeting. In a case where the audience of the meeting cast votes for the candidate images M, members of the audience respectively hold the vote devices Y. In the above case, opinions of the meeting participants and/or opinions of the audience of the meeting can be reflected to determination of the meeting image.

(8) In the second embodiment, the meeting participants are invited to make proposals for the meeting image. However, the present disclosure is not limited to this configuration. The meeting participants and/or the audience of the meeting may be invited to make proposals for the meeting image, and the application images P may be created by the meeting participants and/or the audience of the meeting. In this case, the receiving section 61 invites the proposals for the meeting image from the meeting participants and/or the audience of the meeting and receives the proposals from the meeting participants and/or the audience of the meeting.

(9) In the second embodiment, the meeting participants cast votes for the application images P. However, the present disclosure is not limited to this configuration. The meeting participants and/or the audience of the meeting may cast votes for the application images P. In this case, the first communication section 54 receives information indicating a result of voting on the application images P performed by the meeting participants and/or the audience of the meeting. The image determination section 62 determines at least one image among the application images P as the meeting image on the basis of the result of voting on the application images P performed by the meeting participants and/or the audience of the meeting. In a case where the audience of the meeting cast votes for the application images P, members of the audience respectively hold the operation devices W. In the above case, opinions of the meeting participants and/or opinions of the audience of the meeting can be reflected to determination of the meeting image.

What is claimed is:

1. An information processing device that determines a meeting image representing contents of a meeting, the information processing device comprising:
an image determination section, wherein
the image determination section determines at least one image among a plurality of candidate images as the meeting image on the basis of a result of voting on the candidate images, the candidate images representing contents of the meeting, or
the image determination section determines at least one image among a plurality of application images as the meeting image, the application images having been submitted to the information processing device.

2. The information processing device according to claim 1, further comprising:
an image selection section configured to select the candidate images; and
a first communication section configured to receive information indicating the result of voting on the candidate images.

3. The information processing device according to claim 2, wherein
the image selection section includes:
a search key input device that receives input of a search key;
storage storing therein search information including a plurality of stored images and one or more search keys, the search information associating at least one search key with a stored image among the stored images, each of the stored images having at least one search key associated therewith in the search information; and
a selection section that selects the candidate images from among the stored images on the basis of the search key input to the search key input device and the search information.

4. The information processing device according to claim 2, wherein
the image determination section includes:
a calculation section that calculates rankings of numbers of votes cast for the respective candidate images on the basis of the result of voting on the candidate images; and
a determination section that determines the meeting image from among the candidate images on the basis of the rankings.

5. A meeting assist system comprising:
the information processing device according to claim 2; and
vote devices, wherein
votes for any of the candidate images are cast through the vote devices.

6. The meeting assist system according to claim 5, wherein
the vote devices each include:
a display device that displays a vote reception screen or a vote input screen; and
a switch operation device,
a screen displayed by the display device is switched from the vote reception screen to the vote input screen through the switch operation device,
an image that represents information indicating that the voting is being carried out is displayed on the vote reception screen, and
the candidate images are displayed on the vote input screen.

7. The meeting assist system according to claim 6, wherein
the image determination section includes a calculation section,
the vote devices each further include:
a second communication section that receives information indicating the candidate images selected by the image selection section; and
a vote operation device that receives input of a vote for any of the candidate images,
the second communication section transmits to the first communication section information indicating the vote input to the vote operation device as the result of voting on the candidate images, and
the calculation section calculates numbers of votes cast for the respective candidate images from the result of voting on the candidate images, and calculates rankings of the numbers of votes on the basis of the calculated numbers of votes.

8. The information processing device according to claim 1, further comprising:
a receiving section configured to receive proposals for the meeting image, wherein
the application images are submitted through the receiving section.

9. The information processing device according to claim 8, wherein
the image determination section determines the at least one image among the application images as the meeting image on the basis of a result of voting on the application images.

10. The information processing device according to claim 9, wherein
the image determination section includes:
a calculation section that calculates rankings of numbers of votes cast for the respective application images on the basis of the result of voting on the application images; and
a determination section that determines the meeting image from among the application images on the basis of the rankings.

11. A meeting assist system comprising:
the information processing device according to claim 8;
an image creation device; and
a communication section, wherein
an application image among the application images is created through an operation performed on the image creation device, and
the communication section transmits information indicating the application image created through the operation performed on the image creation device to the receiving section.

12. The meeting assist system according to claim 11, further comprising:
vote devices, wherein
votes are cast for any of the application images through the vote devices, and
the image determination section determines the at least one image among the application images as the meeting image on the basis of a result of voting on the application images.

13. A meeting assist method for determining a meeting image by a meeting assist system implemented by a computer, the meeting image being an image to be displayed during a meeting, the meeting assist method comprising:
determining by an image determination section included in the computer, at least one image among a plurality of candidate images as the meeting image on the basis of a result of voting on the candidate images, the candidate images representing contents of the meeting, or
determining by the image determination section, at least one image among a plurality of application images as the meeting image, the application images having been submitted to the computer.

14. The meeting assist method according to claim 13, further comprising:
selecting the candidate images by an image selection section included in the computer; and
receiving by a vote operation device included in the computer, input of a vote for any of the candidate images.

15. The meeting assist method according to claim 14, wherein
votes are cast for any of the candidate images by either or both of meeting participants and an audience of the meeting.

16. The meeting assist method according to claim 13, further comprising:
receiving by a receiving section included in the computer, proposals for the meeting image.

17. The meeting assist method according to claim 16, wherein
in the receiving, either or both of meeting participants and an audience of the meeting are invited to make proposals for the meeting image.

18. An image forming apparatus comprising:
the information processing device according to claim 1; and
an image forming device configured to form the meeting image on a sheet.
